(19) United States
(12) Patent Application Publication
(10) Pub. No.: US 2019/0300035 A1
(43) Pub. Date: Oct. 3, 2019

(54) STEERABLE OMNI-DIRECTIONAL CART

(71) Applicant: Stanley Black & Decker Inc., New Britain, CT (US)

(72) Inventors: Mark COLTON, Annapolis, MD (US); Matthew J. VELDERMAN, Baltimore, MD (US); Anthony J. ROMANO, Crofton, MD (US); Emanuel MOSHOURIS, Baltimore, MD (US)

(21) Appl. No.: 16/364,631

(22) Filed: Mar. 26, 2019

Related U.S. Application Data
(60) Provisional application No. 62/651,363, filed on Apr. 2, 2018.

(51) Int. Cl. B62B 3/00; B60B 33/08; B60B 19/00; B62B 5/00; B62B 3/02

(52) U.S. Cl. CPC B62B 3/001; B60B 33/08; B60B 19/003; B62B 5/0043; B62B 2301/252; B62B 5/0053; B62B 3/02; B62B 2301/05; B62B 5/005

(57) ABSTRACT

A steerable omni-directional cart is disclosed. The cart includes either a driven wheel or a sphere disposed on a lower surface of the cart platform to provide powered motion to the cart. A mechanical element is provided to allow the direction of the powered motion to be changed by the user to thereby allow the cart to be steered. The power may be provided by a removable and rechargeable battery pack. The battery pack may drive a motor which includes a driven output element in contact with the sphere to provide powered motion. Alternatively, the driven wheel may be a hub driven wheel which is powered by the battery pack.

### FIELD OF THE INVENTION

The present invention relates to movable platform carts for workmen, for example, creepers on which an automobile mechanic lies on his back and maneuvers the cart under a vehicle to perform service.

### BACKGROUND

Omni-directional platform carts and creepers are known and generally include a flat platform supported on four castors. The workmen is supported by the platform and may maneuver the cart or creeper under a vehicle to perform service. Such carts may be manually propelled by the user's foot, or may be power driven.

### SUMMARY OF THE INVENTION

In one embodiment, the invention is directed to a cart. The cart includes a platform and undriven and rotatable castors. A motorized driven wheel is rotatable to allow steering of the cart. A handle is connected to the driven wheel and rotatable along with the driven wheel. The handle may be rotated about a vertical axis by a user to thereby rotate the driven wheel to steer the cart.

In a further embodiment, the invention is directed to a cart including a platform. A plurality of undriven and rotatable castors are disposed under the platform. A sphere is supported on said cart and in contact with a surface on which the cart is to be driven. A support element is rotatably supported by the platform. A motor driven element is supported by the support element so as to rotate therewith. The motor driven element is in driving contact with the sphere so as to drive the sphere about a substantially horizontal axis. A motor drives the motor driven element. A manually grippable steering arm is supported on the support element and is rotatable about a substantially vertical axis to thereby rotate the support element and the motor driven element about a substantially vertical axis. The motor driven element drives the sphere about a substantially horizontal drive axis to create translational movement of the cart, and rotation of the motor driven element by gripping and rotating the steering arm causes corresponding rotation of the sphere drive axis about a substantially vertical axis via the contact between the motor driven element and the sphere to provide for steering of the cart.

In a further embodiment, the invention is directed to a cart including a platform and a plurality of undriven and rotatable castors disposed on the platform. A sphere is supported on the cart and in contact with a surface on which the cart is to be driven. A support element is supported by the platform to be rotatable about a vertical axis. A motor is supported on the support element and has an output shaft and a driven disc disposed thereon, with the driven disc in tangential driving contact with the sphere to drive the sphere to translationally move the sphere and cart. A manually grippable steering arm is supported on the support element to allow for rotation of the support element thereby. Rotation of the steering arm and corresponding rotation of the support element causes corresponding movement of the location of the tangential driving contact about the surface of the sphere to change the direction in which the cart is translationally moved to allow for steering of the cart.

These and other objects, features, and characteristics of the present invention, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural references unless the context clearly dictates otherwise.

### BRIEF DESCRIPTION OF THE DRAWINGS

FIG. 1 is a top perspective view of a platform cart forming part of the first embodiment of the invention.

FIG. 2 is a top perspective view of the platform cart shown in FIG. 1 incorporating a steering and driving mechanism according to a first embodiment of the invention.

FIG. 3 is an explanatory top perspective view showing elements forming the steering and driving mechanism according to the first embodiment.

FIG. 4 is a top perspective view showing the embodiment in FIG. 3 in an assembled state.

FIG. 5 is an opposite side perspective view of the embodiment shown in FIG. 4.

FIG. 6 is a cross-sectional explanatory view taken along line 6-6 shown in FIG. 4.

FIG. 7 is an explanatory side perspective view showing elements forming the invention according to the first embodiment similar to that shown in FIG. 3 but from the opposite side.

FIG. 8 is a perspective view of an example of a motorized hub driven wheel shown in FIGS. 2-6.

FIG. 9 is top perspective view of a steering and driving mechanism according to a second embodiment of the invention.

FIG. 10 is an exploded perspective view of the mechanism shown in FIG. 9.

FIG. 11 is a close up perspective view showing a portion of the steering and driving mechanism of FIG. 9 in accordance with a first alternate embodiment thereof.

FIG. 12 is a close up perspective view showing a portion of the steering and driving mechanism of FIG. 9 in accordance with a second alternate embodiment thereof.

FIG. 13 is an exploded perspective view of the steering and driving mechanism shown in FIG. 12.

FIG. 14 is a side view showing a sphere and cog forming part of the steering and driving mechanism disclosed in FIG. 13.

FIG. 15 is a side view of a steering and driving mechanism according to a third embodiment of the invention.

FIG. 16 is an exploded perspective view of the steering and driving mechanism shown in FIG. 15.

### DETAILED DESCRIPTION OF EXEMPLARY EMBODIMENTS

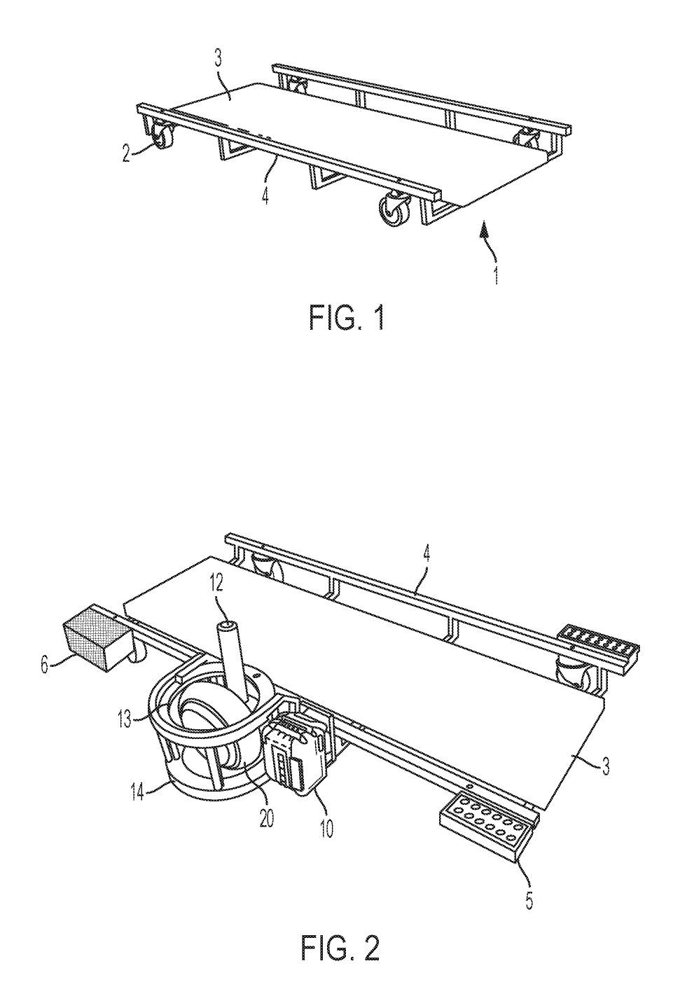

With reference to FIG. 1, omni-directional platform cart 1 includes platform 3 supported by four conventional castors 2 and side rails 4 disposed on either side of platform 3. Castors 2 are mounted in a known manner to be fully rotational about a vertical axis to allow free movement of cart 1 in any direction. In use, a workman lies on his back on platform 3 and moves cart 1 so as to be beneath a vehicle (or other structure) to allow work thereon.

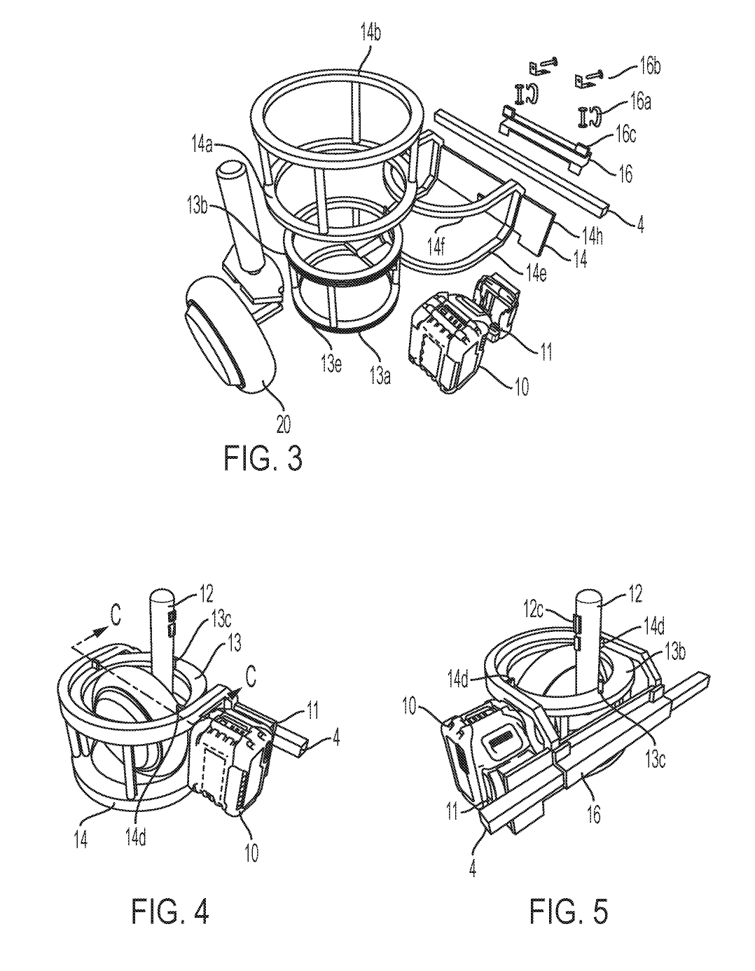

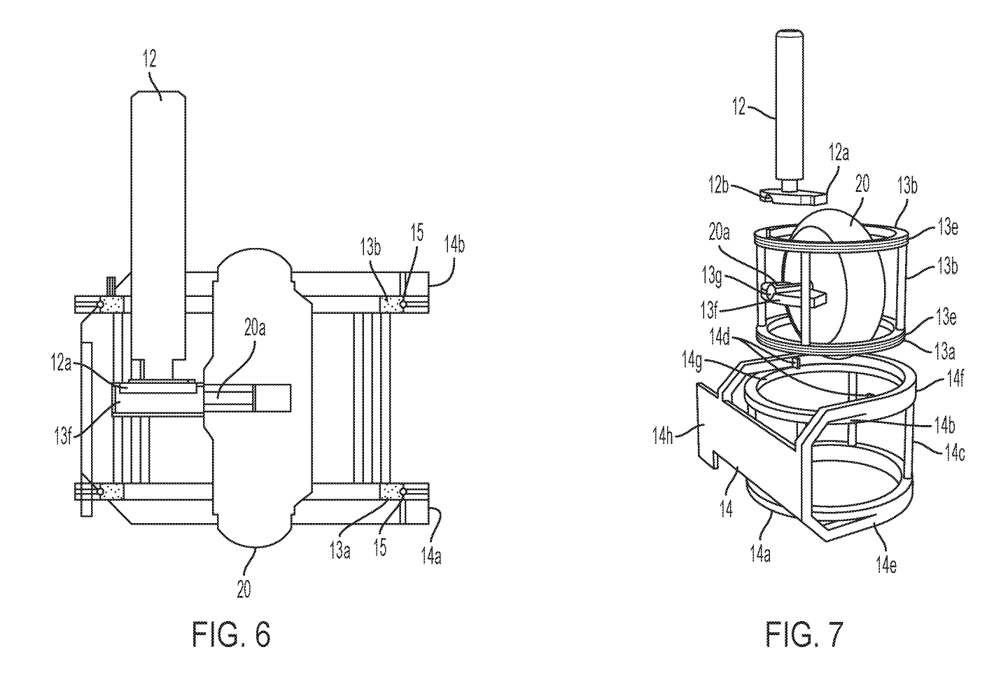

With further reference to FIG. 2-8, a steering and driving mechanism for cart 1 according to a first embodiment is shown. The steering and driving mechanism includes outer ring assembly 14 secured to one side rail 4, inner ring assembly 13 rotatably secured within outer ring assembly 14, rotatable steering handle 12, and motorized hub driven wheel 20, with the latter two elements secured for joint rotation with inner ring assembly 13. The mechanism further includes battery pack 10 which provides power for motorized hub driven wheel 20. Battery pack 10 may be rechargeable and may be slidably disposed in electrical contact with battery 11, with the latter fixed on side rail 4.

Outer ring assembly 14 includes flat panel 14h, having integrally formed upper outer hoop support 14f and lower outer hoop support 14e extending therefrom. With particular reference to FIG. 7, a portion of upper outer hoop support 14f diverges therefrom to form upper outer hoop 14b, and a portion of lower outer hoop support 14e diverges therefrom to form lower outer hoop 14a. The inner surfaces of both upper outer hoop 14b and lower outer hoop 14a each include outer bearing track 14g formed thereon. Vertical support columns 14c extend between upper outer hoop support 14f and lower outer hoop support 14e to provide stability. Two rotational stops 14d extend radially inwardly from upper outer hoop support 14f, generally at the location where upper outer hoop 14b diverges. Rotational stops 14d are disposed at approximately 180° apart from each other. With reference to FIG. 2, upper outer hoop 14b, lower outer hoop 14a and vertical columns 14c can be formed as an integral structure, while lower outer hoop support 14e and upper outer hoop support 14f can be formed as an integral structure with flat panel 14h. The formerly described structure can be fitted between lower outer hoop support 14e and upper outer hoop support 14f and fixedly secured thereto to create integrally formed outer ring assembly 14. Alternatively, outer ring assembly 14 can be formed as a single integral structure.

With reference to FIG. 3, outer ring assembly 14 is secured to cart 1 by placing flat panel 14h against an exterior surface of one of side rails 4. Adjustable mounting bracket 16 having tabs 16b is disposed about side rail 4 such that an interior surface thereof fits within the longitudinal opening of bracket 16. Bracket 16 is made of a flexible material and is secured to side rail 4 with clamp and screw structures 16a which are disposed through a horizontal portion of tabs 16c which extend laterally to the exterior surface of side rail 4. Alternatively, the main portion of bracket 16 could include screw holes which extend laterally over side rail 4 to receive clamp and screw structures 16a. The use of clamp and screw structures 16a allows for bracket 16 to accommodate side rails 4 of different widths and heights Flat panel 14h is then secured to mounting bracket 16 via two sets of washers and screws 16b which extend through openings in flat panel 14h and the vertical portions of tabs 16c. Such openings may be vertical slots to allow for the steering and driving mechanism to be used with carts 1 having side rails 4 which have are disposed at various distances from the ground.

Inner ring assembly 13 includes lower inner hoop 13a and upper inner hoop 13b, each having inner bearing tracks 13e formed on the outer circumferential surfaces thereof. Vertical columns 13d extend between lower inner hoop 13a and upper inner hoop 13b. Integrally formed wheel axle support 13f extends between two of vertical columns 13d, and includes radially extending channel 13g axially formed across the upper surface. Over rotation limit pin 13c extends upwardly from a top surface of upper inner hoop 13b. Inner ring assembly 13 is disposed within outer ring assembly 14, with inner bearing tracks 13e disposed adjacent outer bearing tracks 14g, and ball bearings 15 disposed therebetween to allow rotation of inner ring assembly 13 relative to outer ring assembly 14. This assembly is accomplished by placing ball bearings 15 in outer bearing tracks 14g, followed by press fitting inner ring assembly 13 into outer ring assembly 14 with ball bearings 15 captured by inner bearing tracks 13e. A seal and/or ball spacer could be added to reduce friction and prevent contamination. Over rotation limit pin 13c is disposed in the same plane as over rotation stop surfaces 14d, and contact therebetween limits the degree to which inner ring assembly 13 can rotate within outer ring assembly 14. For example, as shown rotation may be limited to 180°.

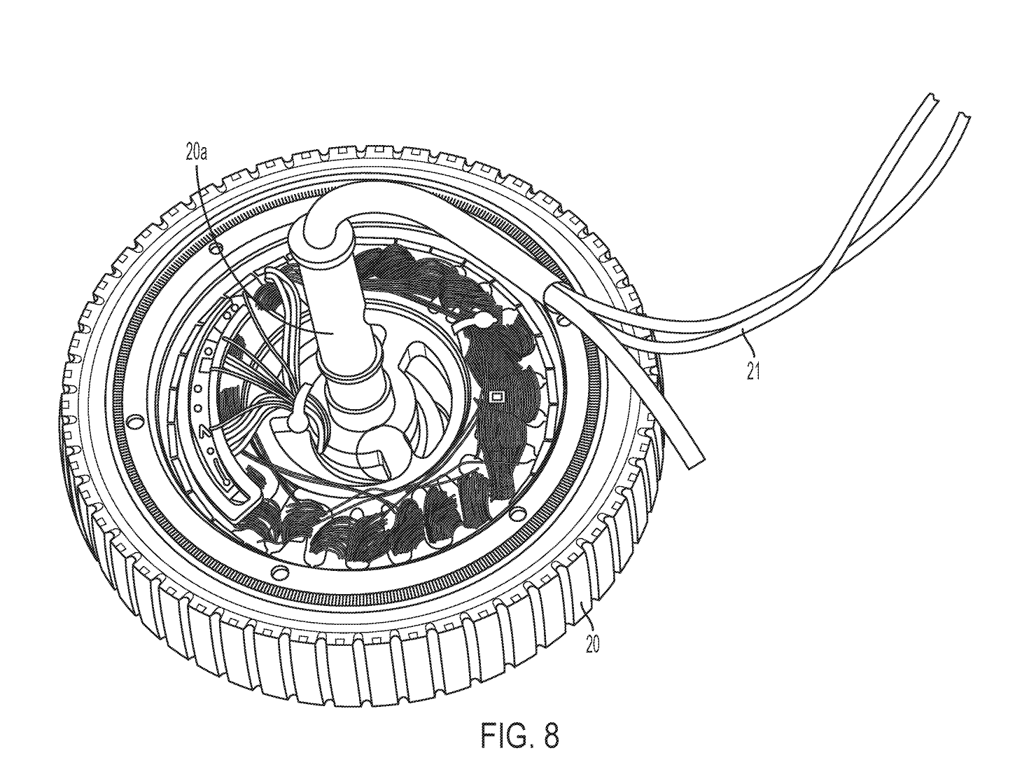

With particular reference to FIGS. 7 and 8, motorized hub driven wheel 20 includes axle 20a which extends from one side thereof. Motorized hub driven wheel 20 is disposed downwardly through the upper open surfaces of inner ring assembly 13 and outer ring assembly 14, and axle 20a fits within radially extending channel 13g. Rotating handle 12 includes lower flange portion 12a having channel 12b, and forward and reverse control buttons 12c (shown in FIG. 5). Handle 12 is disposed through the upper open surfaces with flange portion 12a disposed on top of wheel axle support 13f, with channel 12b surrounding axle 20a on the upper surface thereof. Lower flange portion 12a is secured to wheel axle support 13f via suitable fasteners, to thereby retain motorized hub driven wheel 20 in contact with the ground. The internal motor of hub driven wheel 20 is linked to removable rechargeable battery pack 10 via battery foot 11 and suitable circuitry 21, with the latter extending through axle 20a.

A user may steer platform cart 1 by rotating handle 12, which causes corresponding rotation of motorized hub driven wheel 20 and inner ring assembly 13. Motorized hub driven wheel 20 may be energized by pushing the desired forward or reverse button 12c, which connects motorized hub driven wheel 20 to battery pack 10 to drive hub driven wheel 20 in the desired forward or reverse direction. Since inner ring assembly 13 and thus hub driven wheel 20 may be rotated through 180°, the combination of rotation and energization allows hub driven wheel 20 to be driven in any direction to thereby allow platform cart 1 to be driven in the forward, reverse and both lateral directions, or any direction in between, as desired by the user. Castors 2 freely rotate to follow the direction of translational movement of hub driven wheel 20. Over rotation of hub driven wheel 20 is prevented by the contact of over rotation pin 13c and over rotation stop surfaces 14d. Since battery pack 10 is removably installed in battery foot 10, for example, by use of sliding rails, it can be removed for recharging.

With further reference to FIG. 2, battery pack 10 may be used to power additional elements disposed on cart 1. For example, adjustable light 5 or Bluetooth speaker 6 may be installed on rails 4 and electrically linked to battery pack 10 via battery foot 11 to be powered thereby.

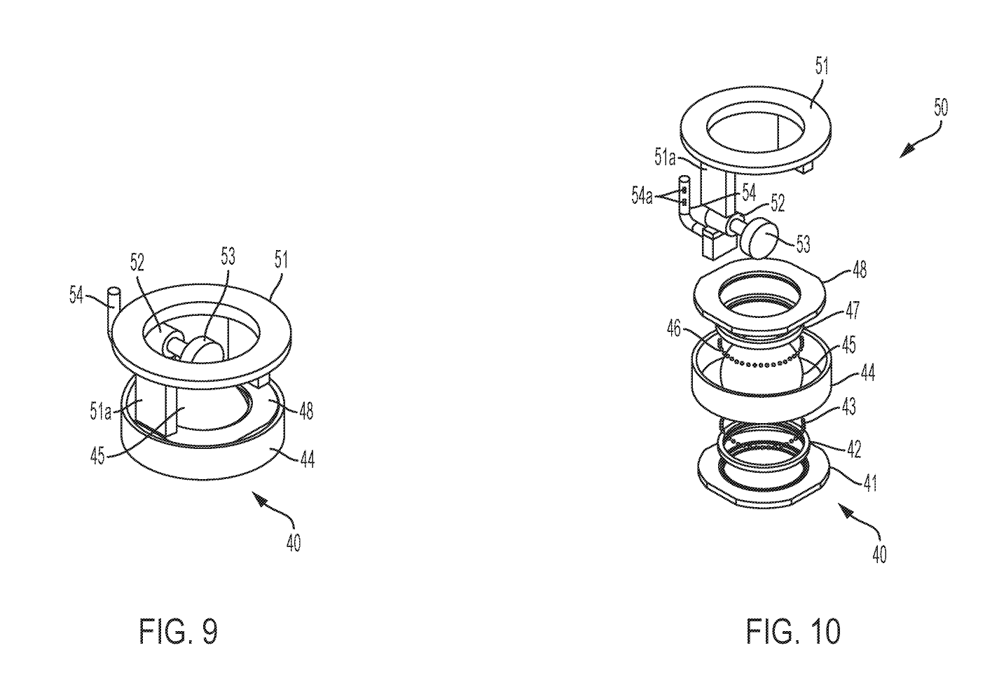

With reference to FIGS. 9 and 10, a second embodiment of the invention is shown. In this embodiment, the structure of the cart would be similar to cart 1 including platform 3, side rails 4 and castors 2 as shown in FIG. 1. The steering and driving mechanism includes slewing bearing assembly 40 which includes lower end cap 41 having a disc shaped central opening, and lower bearing race 42 extending upwardly from the circumference of the disc. Slewing bearing assembly 40 further includes upper end cap 48 which also has a disc-shaped central opening and upper bearing race 47 extending downwardly from the circumference of the disc. Driven sphere 45 is secured between lower end cap 41 and upper end cap 48, with a plurality of lower ball bearings 43 and upper ball bearings 46 disposed between sphere 45 and bearing races 41 and 47 to thereby allow driven sphere 45 to roll freely about its vertical axis and any horizontal axis. Lower end cap 41 and upper end cap 48 are secured to lower and upper surfaces of frame 44 to create an integral slewing bearing assembly 40, with driven sphere 45 extending outwardly of the upper and lower surfaces.

The steering and driving mechanism further includes steering frame 50 which includes turning disc 51 having two vertically descending columns 51a which are integrally formed with or otherwise secured to the upper surface of upper end cap 48. Motor 52 is secured through an opening in one column 51a, with driven output disc 53 secured on the output shaft of motor 52. Driven output disc 53 is disposed in driving contact with the upper arc of a vertically oriented circumference of driven sphere 45 such that rotation of output disc 53 causes driven sphere 45 to roll in the same direction in which disc 53 is oriented, that is, driven sphere moves (forwardly or rearwardly) in a direction contained in a plane generally defined by the plane in which disc 53 rotates. Steering arm 54 extends outwardly from arm 51a opposite of motor 52. Platform 3 would include a cadge or other suitable framing to which frame 44 is secured so that the combined assembly of slewing bearing assembly 40 and steering frame 50 is secured beneath platform, with a vertical portion of steering arm 54 extending upwardly above and outwardly of one side rail 4 so as to be grippable by an operator. The assembly is secured in a manner which allows turning disc 51 to freely rotate, with sphere 45 contacting the ground. End cap 48 freely rotates within frame 44 along with turning disc 51. Preferably, the combined structure of the steering and driving mechanism is disposed beneath the center of platform 3, with the horizontal section of steering arm 54 long enough to allow the vertical portion to rotate through 180° along the side of a cart.

The cart according to the second embodiment further includes removable rechargeable battery pack 10 slidably received in battery foot 11 as shown in FIG. 2. Steering arm 54 also included forward and reverse power buttons 54a. In operation, the user presses one of buttons 54a to cause motor 52 and driven output disc 53 to rotate in a forward or reverse direction, thereby causing sphere 45 to also rotate about a horizontal axis to provide translational motion of the cart. The user may rotate steering arm 54 to thereby rotate steering frame 50 relative to frame 44, with the frictional contact line between output disc 53 and driven sphere 45 also rotating about a vertical axis. The frictional contact line may rotate due to output disc 53 sliding over the top of sphere 45, or alternatively the friction between disc 53 and sphere 45 may cause sphere to rotate along disc 53. The rotation of this contact line causes corresponding rotation of the horizontal axis about which driven sphere 45 is driven in rotation, thereby rotating the rolling direction of driven sphere 45. Therefore, the user can control the steering direction of the cart by rotating steering arm 54 as desired, and selecting forward or reverse drive for motor 52.

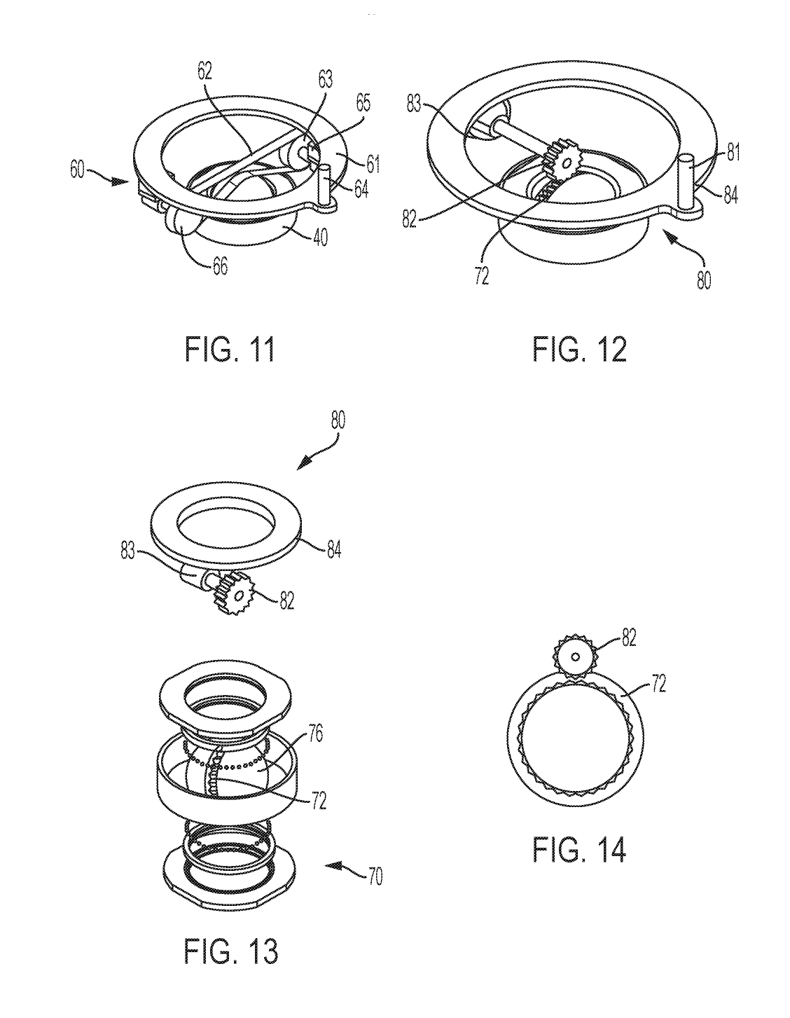

With reference to FIG. 11, a first alternative of the embodiment of the invention disclosed with reference to FIGS. 9 and 10 is disclosed. In this embodiment, the structure of the cart would again be similar to what is shown in FIG. 2, with slewing bearing assembly 40 as described above also forming part of this embodiment. The first alternative also includes steering frame 60, which further includes turning disc 61 which supports motor and output shaft 65 from a lower surface thereof, for example, via a vertical column. Motor and output shaft 65 further supports drive output pulley 63. Idler pulley 66 is rotatably supported on turning disc 61 opposite driven output pulley 63, and drive belt 62 is disposed thereabout and in driving contact with driven sphere 45 along an upper arc of a vertical circumference thereof, similar to the manner in which driven output disc 53 contacts sphere 45 in FIGS. 9-10. Turning disc 61 further includes support arm 64 having forward and reverse buttons to control battery pack 10 to rotate driven output pulley 63 in either the clockwise or counterclockwise direction, to thereby cause drive belt 62 to be driven in a corresponding direction. Turning disc 61 has a diameter sufficient to allow support arm 64 to be disposed outwardly of platform 3 and rails 4. Sphere 45 is driven to rotate in a forward or reverse direction about a horizontal axis via the frictional contact of drive belt 62 thereon. Rotation of turning disc 61 via steering arm 64 causes the orientation of drive belt 62 to rotate about a vertical axis, and as in the embodiment described with respect to FIGS. 9-10, the orientation of the horizontal drive axis of sphere 45 is rotated about a vertical axis as well. The friction between belt 62 and sphere 45 causes sphere 45 to rotate along with belt 62. Therefore, the user may control both the orientation and drive direction of sphere 45 in order to steer the platform cart.

With reference to FIGS. 12-14, a second alternative of the embodiment of the invention disclosed with reference to FIGS. 9 and 10 is disclosed. In this embodiment, the overall structure of the cart would be similar as shown in FIG. 2, with slewing bearing assembly 70 similar to slewing bearing assembly 40 as described above forming part of this embodiment. However, slewing bearing assembly 70 also includes driven sphere 76 having recessed gear track 72 formed in an arc extending along an upper portion of the vertical circumference. Furthermore, steering frame 80 includes turning disc 81 having steering arm 84 extending upwardly therefrom. Turning disc 81 also supports motor and output shaft 83 from a lower surface thereof, for example, via a vertical column. Motor and output shaft 83 further includes driven output cog 82 which engages with recessed gear track 72. Steering arm 84 further includes forward and reverse buttons to control battery pack 10 to rotate driven output cog 83 in either the clockwise or counterclockwise direction, to thereby cause driven sphere 76 to be driven to rotate in a forward or reverse direction about a horizontal axis. Rotations of turning disc 81 via steering arm 84 causes the orientation of driven output cog 82 to rotate about a vertical axis, and as in the embodiment described with respect to FIGS. 9-10, the orientation of the horizontal drive axis of sphere 76 is rotated about a vertical axis as well. Therefore, the user may control both the orientation and drive direction of sphere 76 to steer the cart.

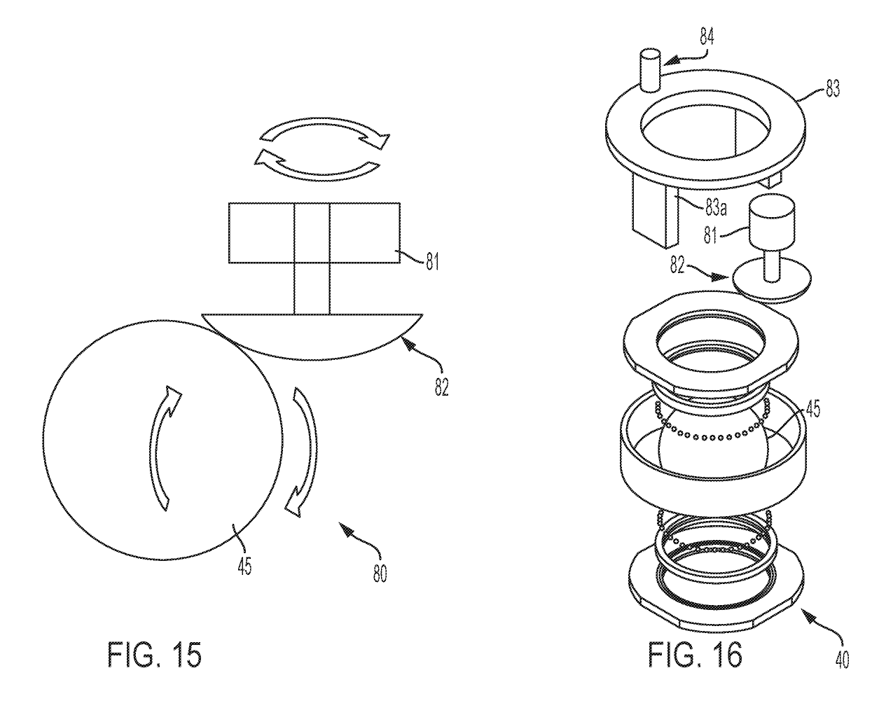

With reference to FIGS. 15 and 16, a third embodiment of the invention is shown. In the third embodiment, the cart, slewing bearing assembly 40 and sphere 45 have the same structure as in the embodiment shown in FIGS. 9-10. The third embodiment further includes steering frame 80 having turning disc 83 with vertically descending columns 83a linked to the upper end cap.

Steering arm 84 extends upwardly. Motor 81 is secured on turning disc 83 and driven dome 82 is secured on the output shaft thereof. Driven dome 82 is disposed in contact with sphere 45 along a horizontal tangential thereof. As shown by the arrows, driven dome 82 is rotated about a vertical axis, thereby causing sphere 45 to rotate about a horizontal axis, which further causes sphere 45 to undergo translational motion to drive platform cart 1 in a forward or reverse direction. The operator can steer platform cart 1 by rotating turning disc 83 to thereby rotate the horizontal drive axis of sphere 45.

While the invention has been described by way of exemplary embodiments, it is understood that the words which have been used herein are words of description, rather than words of limitation. Changes may be made within the purview of the appended claims, without departing from the scope and spirit of the invention in its broader aspects.

What is claimed is:

1. A cart comprising:
a platform;
a plurality of undriven and rotatable castors;
a motorized driven wheel, said driven wheel rotatable to allow steering of said cart; and
a handle connected to the driven wheel and rotatable along with the driven wheel, wherein, said handle may be rotated about a vertical axis by a user to thereby rotate the driven wheel to steer said cart.

2. The cart recited in claim 1 further comprising:
an outer ring assembly fixed relative to said platform; and
an inner ring assembly rotatably secured within said outer ring assembly; wherein
said motorized driven wheel is secured to said inner ring assembly to allow rotation thereof relative to said outer ring assembly and said platform.

3. The cart recited in claim 2 further comprising:
a side rail fixed to said platform, said outer ring assembly fixed to said side rail.

4. The cart recited in claim 3 further comprising:
a battery, wherein, said motorized driven wheel is a hub driven wheel and said battery is electrically linked to said hub driven wheel and is controlled by a switch on said handle to energize said hub driven wheel to provide powered movement to said cart.

5. The cart recited in claim 4, wherein said battery is a rechargeable battery which is removably securable to said side rail.

6. The cart recited in claim 4, said hub driven wheel including an axle having a portion extending from a side surface thereof, said inner ring assembly including an integrally formed wheel axle support, and said handle including a lower handle support, wherein said axle extending portion is clamped between said wheel axle support and said lower handle support to secure said hub driven wheel to said inner ring assembly.

7. The cart recited in claim 3, said outer ring assembly including a flat surface portion fixedly securable on said rail and an outer ring hoop section having an outer bearing track, said inner ring assembly including an inner hoop section having an inner bearing track disposed adjacent said outer bearing track, said cart further including a plurality of ball bearings disposed between said inner bearing track and said outer bearing track.

8. The cart recited in claim 7, said outer ring hoop section including an over rotation stop surface formed thereon, said inner ring hoop section including an over rotation stop pin projecting therefrom, wherein contact between said stop surface and said stop pin limits the degree to which said inner hoop section may rotate relative to the outer hoop section to thereby prevent over rotation.

9. The cart recited in claim 8, said outer over rotation stop surface comprising a projection extending vertically from a surface of said outer ring hoop section, and said stop pin projection projecting vertically from a surface of said inner hoop section.

10. The cart recited in claim 8, the degree of rotation of said inner hoop section relative to said outer hoop section limited to no more than 180 degrees.

11. The cart recited in claim 1 further comprising:
a rail extending along at least one side of said platform;
a battery removably disposable on said rail; and
an electrically power device removably disposable on said rail and powered by said battery.

12. A cart comprising:
a platform;
a plurality of undriven and rotatable castors disposed on said platform;
a sphere supported on said cart and in contact with a surface on which the cart is to be driven;
a support element rotatably supported by said platform;
a motor driven element supported by said support element so as to rotate therewith, said motor driven element in driving contact with said sphere so as to drive said sphere about a substantially horizontal axis;
a motor driving said motor driven element; and
a manually grippable steering arm supported on said support element, said steering arm rotatable about a substantially vertical axis to thereby rotate said support element and said motor driven element about a substantially vertical axis, wherein, the motor driven element drives the sphere about a substantially horizontal drive axis to create translational movement of the cart, and rotation of the motor driven element by gripping and rotating said steering arm causes corresponding rotation of the sphere drive axis about a substantially vertical axis to provide for steering of the cart.

13. The cart recited in claim 12, wherein,
said support element is a disc rotatably supported by said platform and said steering arm is physically connected to said support element, and said motor driven element is a driven disc rotatably supported on an output shaft of said motor and in contact with said sphere at said substantially vertical axis of said sphere.

14. The cart recited in claim 12, wherein
said support element is a disc rotatably supported on said platform and said steering arm is physically connected to said support element, and said motor driven element is a drive belt disposed about two pulleys supported by said support element, one of said pulleys rotatably supported on an output shaft of said motor, said pulley in contact with said sphere at said substantially vertical axis of said sphere.

15. The cart recited in claim 12, wherein,
said support element is a disc rotatably supported by said platform and said steering arm is physically connected to said support element,
said motor driven element is a driven output cog disc rotatably supported on an output shaft of said motor, and
said sphere including a recessed gear track formed along an arcuate portion extending along a circumference of said sphere, said output cog disposed in said gear track and driven by said motor to drive said sphere about the substantially horizontal axis.

16. A cart comprising:
a platform;
a plurality of undriven and rotatable castors disposed on said platform;
a sphere supported on said cart and in contact with a surface on which the cart is to be driven;
a support element supported by said platform to be rotatable about a vertical axis;
a motor supported on said support element and having an output shaft and a driven disc disposed thereon, said driven disc in tangential driving contact with said sphere to drive said sphere to translationally move said sphere and cart; and
a manually grippable steering arm supported on said support element to allow for rotation of said support element thereby;
wherein rotation of said steering arm and corresponding rotation of said support element causes corresponding movement of the location of the tangential driving contact about the surface of the sphere to change the direction in which the cart is translationally moved to allow for steering of the cart.
